(19) United States
(12) Patent Application Publication
(10) Pub. No.: US 2016/0289932 A1
(43) Pub. Date: Oct. 6, 2016

(54) Water Dispenser with Handle-less Control

(71) Applicants: Shovkat Mirakhimov, Las Vegas, NV (US); Omar Rocha, Las Vegas, NV (US)

(72) Inventors: Shovkat Mirakhimov, Las Vegas, NV (US); Omar Rocha, Las Vegas, NV (US)

(21) Appl. No.: 15/051,650

(22) Filed: Feb. 23, 2016

Related U.S. Application Data
(60) Provisional application No. 62/177,991, filed on Mar. 30, 2015.

(51) Int. Cl. E03C 1/05; E03C 1/04; F16K 31/06

(52) U.S. Cl. CPC E03C 1/055; F16K 31/06; E03C 1/0401; E03C 2001/026

(57) ABSTRACT

A water dispenser, which is for controlling a water flow of a water dispensation having a water outlet, includes a faucet adapted for mounting on a counter and an operating mechanism which includes a switch being supporting under the counter, a valve operatively linked to the switch for operatively mounting at the water outlet, and a hosting object magnetically connected to the switch when moving the hosting object on the counter. When the hosting object is moved to align with the switch, the valve is actuated at an opened position for allowing water to flow to the faucet. When the hosting object is moved away from the switch, the valve is actuated at a closed position for blocking the water to flow to the faucet.

### CROSS REFERENCE OF RELATED APPLICATION

This is a non-provisional application that claims priority to U.S. provisional application, application No. 62/177,991, filed Mar. 30, 2015, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a water dispenser, and more particularly to a water dispenser with a handle-less control, which simplifies both the maintenance and manual operation of a sink through the elimination of faucet handles.

2. Description of Related Arts

A conventional water dispenser, such as a sink faucet, comprises a handle to selectively switch on-and-off the faucet and to selectively adjust the water temperature. However, the handle collects mold and mildew, and is difficult in cleaning. Once the handle is broken, the sink faucet cannot be operated anymore. The frequently movement of the handle will also cause the water leakage of the sink faucet.

### SUMMARY OF THE PRESENT INVENTION

The invention is advantageous in that it provides a water dispenser which can be a sink faucet that operates by magnetic impetus instead of faucet handles, and that can provide water at multiple temperatures without said handles. With the absence of handles their collection of mold and mildew and their difficulty in cleaning is eliminated. Without said handles the faucet is easy to operate, and additional counter space is provided, as well.

Additional advantages and features of the invention will become apparent from the description which follows, and may be realized by means of the instrumentalities and combinations particular point out in the appended claims.

According to the present invention, the foregoing and other objects and advantages are attained by a water dispenser for controlling a water flow of a water dispensation having a water outlet, comprising a faucet adapted for mounting on a counter and an operating mechanism.

The an operating mechanism comprises:

a switch means arranged for being supporting under the counter;

a valve means operatively linked to the switch means for operatively mounting at the water outlet, wherein the valve means is selectively actuated by the switch means between an opened position and a closed position; and

a hosting object magnetically connected to the switch means when moving the hosting object on the counter to align with the switch means, wherein when the hosting object is moved to align with and activate the switch means, the valve means is actuated at the opened position for allowing water to flow to the faucet, and when the hosting object is moved away from the switch means, the valve means is actuated at the closed position for blocking the water to flow to the faucet.

In accordance with another aspect of the invention, the present invention comprises an operating mechanism for controlling a water flow of a water dispensation having a faucet mounted on top of a counter and a water outlet connected to the faucet, comprising:

a switch means arranged for being supporting under the counter;

a valve means operatively linked to the switch means for operatively mounting at the water outlet, wherein the valve means is selectively actuated by the switch means between an opened position and a closed position; and

a hosting object magnetically connected to the switch means when moving the hosting object on the counter to align with and activate the switch means, wherein when the hosting object is moved to align with the switch means, the valve means is actuated at the opened position for allowing water to flow to the faucet, and when the hosting object is moved away from the switch means, the valve means is actuated at the closed position for blocking the water to flow to the faucet.

In accordance with another aspect of the invention, the present invention comprises a method of controlling a water flow of a water dispensation having a faucet mounted on top of a counter and a water outlet connected to the faucet, comprising the following steps.

(1) Mount a switch means under the counter.

(2) Operatively mount a valve means at the water outlet, wherein the valve means is actuated via the switch means.

(3) Actuate the valve means at an opened position by moving a hosting object on the counter to align with and activate the switch means and to magnetically connected to the switch means, so as to allow water to flow to the faucet.

(4) Actuate the valve means at a closed position by moving the hosting object on the counter to misalign with the switch means so as to block the water to flow to the faucet.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a diagram illustrating the configuration of a water dispenser according to a preferred embodiment of the present invention.

FIG. 2 illustrates the water dispenser installed on a counter according to the above preferred embodiment of the present invention.

FIG. 3 illustrates the markers of the water dispenser on the counter according to the above preferred embodiment of the present invention.

FIG. 4 illustrates the hosting object of the water dispenser on the first marker for cold water dispensation according to the above preferred embodiment of the present invention.

FIG. 5 illustrates the hosting object of the water dispenser on the second marker for warm water dispensation according to the above preferred embodiment of the present invention.

FIG. 6 illustrates the hosting object of the water dispenser on the third marker for hot water dispensation according to the above preferred embodiment of the present invention.

FIG. 7 illustrates various designs of the hosting object of the water dispenser according to the above preferred embodiment of the present invention.

FIG. 8 illustrates the switches of the water dispenser under the counter according to the above preferred embodiment of the present invention.

FIG. 9 illustrates the valve controls of the water dispenser to the water switches according to the above preferred embodiment of the present invention.

FIG. 10 illustrates the power source of the water dispenser according to the above preferred embodiment of the present invention.

FIG. 11 illustrates the connection configuration of the water dispenser to the water switches according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

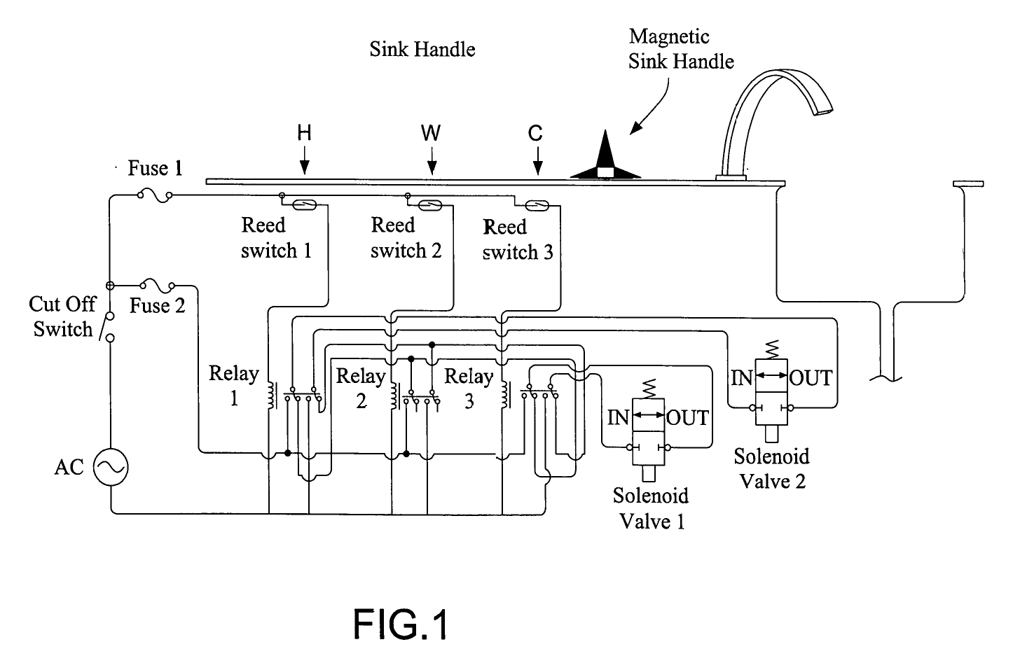

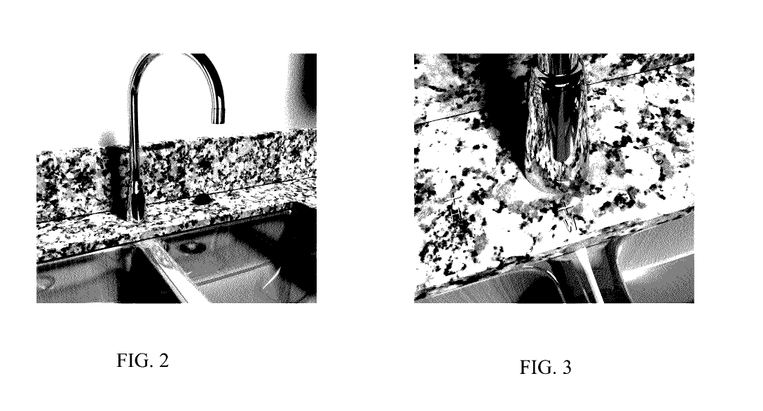

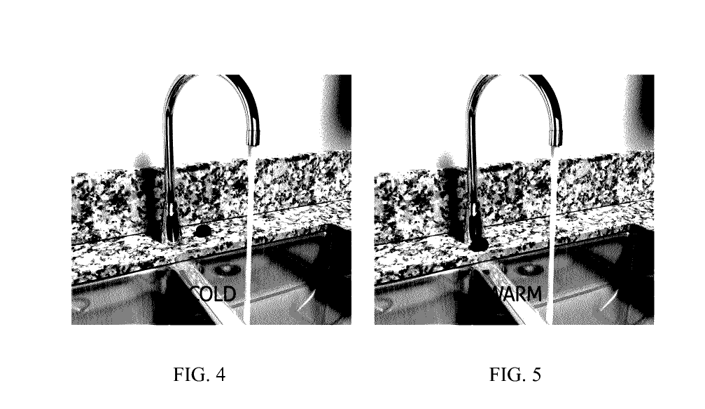

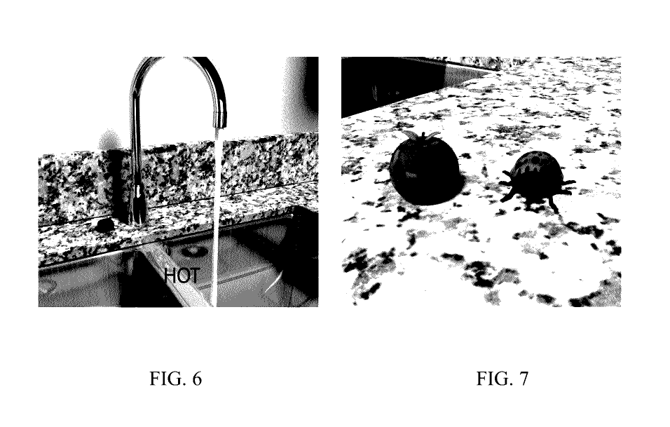

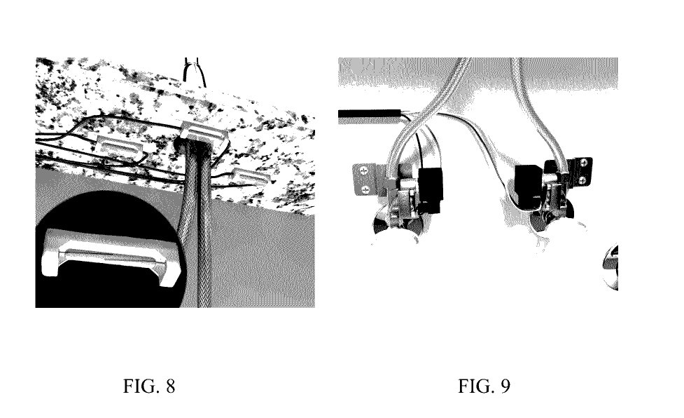

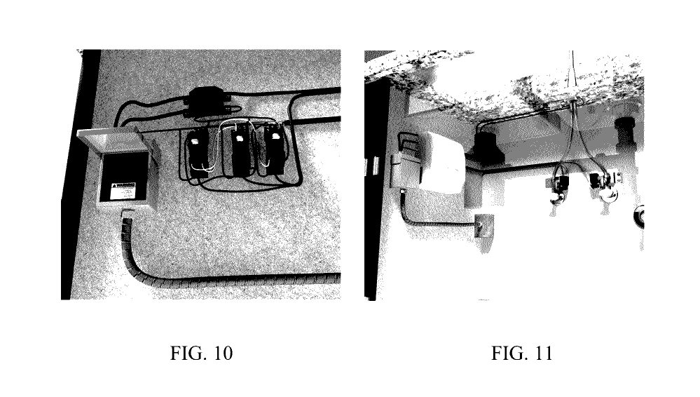

Referring to FIG. 1 of the drawings, a water dispenser according to a preferred embodiment of the present invention is illustrated.

Specific, Unique Function or Property of Invention: The “Water dispenser” is a sink faucet that operates by magnetic impetus instead of faucet handles, and that can provide water at multiple temperatures without said handles. With the absence of handles their collection of mold and mildew and their difficulty in cleaning is eliminated. Without said handles the faucet is easy to operate, and additional counter space is provided, as well.

Invention Features: The “Water dispenser” features a faucet, and an operating mechanism mounted below the counter.

Said operating mechanism features three (3) magnetic reed switches, and that individually connect to three (3) corresponding relay switches. All said switches connect to two (2) featured solenoids of select correspondence, and two (2) fuses are featured, as well.

The magnetic reed switches are supporting under the counter. In particular, the magnetic reed switches are mounted on a bottom surface of the counter. The solenoids valve are operatively linked to the switches for operatively mounting at the cold water outlet and hot water outlet respectively, wherein the valve is selectively actuated by the switch between an opened position and a closed position.

Wiring that connects these components, as well as to a power source, is also featured, as is a cut-off safety switch.

A magnetic object that instigates activation of the operating mechanism is also featured. Accordingly, the magnetic object serves as the hosting object magnetically connected to the switch when moving the hosting object on the counter to align with the switch. When the hosting object is moved to align with and activate the switch, the valve is actuated at the opened position for allowing water to flow to the faucet. When the hosting object is moved away from the switch, the valve is actuated at the closed position for blocking the water to flow to the faucet.

Invention Benefits: The “Water dispenser” operates a sink faucet.

The “Water dispenser” operates a sink faucet without the need for faucet handles.

The “Water dispenser” operates by magnetic control of its operating mechanism.

The magnetic object of the “Water dispenser” induces operation of the magnetic reed switches hosted under the counter of the sink.

The magnetic reed switches of the “Water dispenser” activate the corresponding relay switches.

The relay switches of the “Water dispenser” activate the corresponding solenoids.

The solenoids of the “Water dispenser” activate operation of the faucet for dispensation of water.

The “Water dispenser” features multiple temperature settings, allowing dispensation of hot, warm, or cold water.

The “Water dispenser” requires no handles for operation of its sink faucet.

By requiring no handles, the “Water dispenser” eliminates the problems said handles ordinarily impose.

Without handles, the “Water dispenser” is not subject to the collection of mold or mildew at the base of or on said handles.

Without handles, the “Water dispenser” is not subject to corrosion on said handles.

Without handles, the “Water dispenser” is not subject to water leakage from the base of said handles.

Without handles, the “Water dispenser” is easier to clean than are standard sink faucets and their hosting counters.

Without handles, the “Water dispenser” assumes less counter space than standard sink faucets.

Without handles, the “Water dispenser” allows greater counter space for completion of other tasks.

The “Water dispenser” is exceptionally easy to operate.

The “Water dispenser” requires no handle operation to activate water dispensation from its faucet.

Requiring no handle operation allows the “Water dispenser” to satisfy needs of particular users.

The “Water dispenser” can be easily operated by persons with arthritis, carpal tunnel syndrome, and other hand-, wrist-, and digit-limiting disorders.

The “Water dispenser” can be operated by persons with the aforementioned and other relevant disorders without producing pain ordinarily generated by those disorders during such operation.

The “Water dispenser” benefits persons who need to quickly operate faucets.

The “Water dispenser” benefits persons employed in culinary fields, who often need quick and simply-activated access to water during preparations.

The “Water dispenser” benefits persons employed in scientific and/or medical and/or laboratory fields, who often need quick and simply-activated access to water for washing and sterilization.

The “Water dispenser” allows individual settings of hot, warm, and cold.

The “Water dispenser” allows those individual settings of water temperature to be conducted very easily.

By allowing pre-setting of temperatures, the “Water dispenser” helps users achieve desired and favored temperatures faster.

By allowing rapid realization of desired temperatures, the “Water dispenser” saves time for its users.

By allowing rapid realization of desired temperatures, the “Water dispenser” prevents water waste.

By preventing water waste, the “Water dispenser” helps its users realize lower utility costs.

By preventing water waste, the “Water dispenser” helps its users promote and practice environmental responsibility.

The “Water dispenser” is easier to operate than are other sink faucets without handles.

The “Water dispenser” requires no infrared sensor, unlike other sink faucets without handles.

The “Water dispenser” doesn't sporadically cease operation during use, unlike sink faucets with infrared sensors.

The “Water dispenser” can allow consistent water flow for desired tasks, such as but not limited to washing, rinsing, and filling containers, unlike sink faucets with infrared sensors.

The fuses of the “Water dispenser” provide over-current protection.

The electrical components of the “Water dispenser” are protectively contained to prevent its exposure to water, dust, fumes, humidity, and other contaminants.

The “Water dispenser” requires no drilling in a hosting counter for inclusion of handles.

The “Water dispenser” offers a new and modern design to its environments of use.

The “Water dispenser” can be featured in new homes and other structures.

The “Water dispenser” can appeal to the many who remodel their current residences and other structures.

Invention Variations: The “Water dispenser” can include various designs of faucets.

The magnet-hosting object of the “Water dispenser” can be of various shapes, sizes, and designs.

The magnetic reed switches of the “Water dispenser” can be positioned at various locations, in various patterns, and at various distances from each other.

The “Water dispenser” can offer various temperature settings, and which may or may not be controlled by the user and/or installer.

The “Water dispenser” can be made in variations that include a timer setting, and that ceases water flow from the faucet after a pre-set time period.

The “Water dispenser” can be made in variations that include marking devices including but not limited to marking implements made on a hosting counter, that indicate exactly where the magnetic object should be to achieve water flow activation at desired temperatures. In such variations, the “Water dispenser” can be made for specific application upon particular lines and/or brands of countertop material.

Preferably, the marking devices are different markers which are configured for representing cold water, warm water, and cold water respectively and for being spacedly formed on a top surface of the counter.

The “Water dispenser” can be made in variations that are powered by, or that include as power back-up, a direct current (DC) source.

The “Water dispenser” can be made in variations that include, and as a component of its faucet, a handle for manual operation when desired.

The “Water dispenser” can be made in variations intended for use in residential, commercial, scientific, medical, and/or laboratory environments.

Mechanical Description: (This mechanical description is provided for specificity purposes only, and is not intended in any way to limit the dimensions, materials of production and/or scope of use regarding the “Water dispenser.”)

The “Water dispenser” includes a faucet, and an operating mechanism mounted below the counter which hosts said faucet.

Included in that operating mechanism are three (3) magnetic reed switches, each with hosting bracket and each sealed within glass. Said magnetic reed switches are strategically positioned, and are individually connected to three (3) corresponding relay switches.

Both the set of magnetic reed switches and the set of relay switches connect to individual solenoids, totaling two (2) said solenoids in the operating mechanism.

The aforementioned components of the operating mechanism include wiring for its connection to an alternative current (AC) power source of one hundred-and-ten volt (110V) capacity. Two (2) fuses are featured as well as a cut-off safety switch that is positioned directly between that wiring and the power source.

A separate magnetic object is included for operation of the “Water dispenser.” Said object is, but is not limited to, depiction as a natural rock of aggregate variety.

Usage: After installation of the “Water dispenser,” a user may operate it by moving the magnetic object upon the surface of its hosting counter.

When the user desires water of a cold temperature, he or she may simply slide the magnetic object upon the counter to the contact point of such setting. The user may do the same action when desiring warm or hot water, and simply by sliding the magnetic object to the corresponding points of the counter that produce those temperatures.

When the water flow is no longer needed, he or she may simply slide the magnetic object to a neutral point, in which water flow will cease.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A water dispenser for controlling a water flow of a water dispensation having a water outlet, comprising:
a faucet adapted for mounting on a counter; and
an operating mechanism, which comprises:
a switch means arranged for being supporting under the counter;
a valve means operatively linked to said switch means for operatively mounting at the water outlet, wherein said valve means is selectively actuated by said switch means between an opened position and a closed position; and
a hosting object magnetically connected to said switch means when moving said hosting object on the counter to align with said switch means, wherein when said hosting object is moved to align with and activate said switch means, said valve means is actuated at said opened position for allowing water to flow to said faucet, and when said hosting object is moved away from said switch means, said valve means is actuated at said closed position for blocking the water to flow to said faucet.

2. The water dispenser, as recited in claim 1, wherein said operating mechanism has a contact point defined on a top surface of the counter to align with said switch means and a natural point defined on the top surface of the counter to misalign with said switch means.

3. The water dispenser, as recited in claim 1, wherein said operating mechanism further comprises at least a marker being formed on a top surface of the counter, wherein said marker is aligned with said switch means to guide said hosting object for being placed on the top surface of the counter so as to magnetically connected to said switch means.

4. The water dispenser, as recited in claim 1, wherein said switch means is a magnetic reed switch for being mounted on a bottom surface of the counter, and said hosting object comprises a magnetic element that instigates activation of said magnetic reed switch.

5. The water dispenser, as recited in claim 1, wherein said valve means is a solenoid for operatively mounting to the water outlet.

6. The water dispenser, as recited in claim 1, wherein said operating mechanism further comprises a relay switch operatively connected between said switch means and said valve means.

7. The water dispenser, as recited in claim 1, wherein said operating mechanism further comprises a wiring system extended from said valve means for connecting with a power source, and a cut-off safety switch operatively linked between said wiring system and said power source.

8. The water dispenser, as recited in claim 1, wherein said valve means comprises two solenoids for operatively mounting to a cold water outlet and a hot water outlet, wherein said switch means comprises three magnetic reed switches operatively connected to said solenoids and for being mounted on a bottom surface of the counter, such that said solenoids are selectively by one or more of said magnetic reed switches for controlling a water temperature of the water to flow to said faucet.

9. The water dispenser, as recited in claim 8, wherein said operating mechanism further comprises a three different markers which are configured for representing cold water, warm water, and cold water respectively and for being spacedly formed on a top surface of the counter, wherein said markers are aligned with said magnetic reed switches respectively to guide said hosting object for being placed on the top surface of the counter, so as to magnetically connected to one of said magnetic reed switches.

10. The water dispenser, as recited in claim 1, wherein said faucet is a handle-less faucet.

11. An operating mechanism for controlling a water flow of a water dispensation having a faucet mounted on top of a counter and a water outlet connected to the faucet, comprising:
a switch means arranged for being supporting under the counter;
a valve means operatively linked to said switch means for operatively mounting at the water outlet, wherein said valve means is selectively actuated by said switch means between an opened position and a closed position; and
a hosting object magnetically connected to said switch means when moving said hosting object on the counter to align with and activate said switch means, wherein when said hosting object is moved to align with said switch means, said valve means is actuated at said opened position for allowing water to flow to said faucet, and when said hosting object is moved away from said switch means, said valve means is actuated at said closed position for blocking the water to flow to said faucet.

12. The operating mechanism, as recited in claim 11, wherein said operating mechanism further comprises at least a marker being formed on a top surface of the counter, wherein said marker is aligned with said switch means to guide said hosting object for being placed on the top surface of the counter so as to magnetically connected to said switch means.

13. The operating mechanism, as recited in claim 11, wherein said switch means is a magnetic reed switch for being mounted on a bottom surface of the counter, and said hosting object comprises a magnetic element that instigates activation of said magnetic reed switch.

14. The operating mechanism, as recited in claim 11, wherein said valve means is a solenoid for operatively mounting to the water outlet.

15. The operating mechanism, as recited in claim 11, wherein said operating mechanism further comprises a relay switch operatively connected between said switch means and said valve means, a wiring system extended from said valve means for connecting with a power source, and a cut-off safety switch operatively linked between said wiring system and said power source.

16. A method of controlling a water flow of a water dispensation having a faucet mounted on top of a counter and a water outlet connected to the faucet, comprising the steps of:
(a) mounting a switch means under the counter;
(b) operatively mounting a valve means at the water outlet, wherein said valve means is actuated via said switch means;
(c) actuating said valve means at an opened position by moving a hosting object on the counter to align with and activate said switch means and to magnetically connected to said switch means, so as to allow water to flow to said faucet; and
(d) actuating said valve means at a closed position by moving said hosting object on the counter to misalign with said switch means so as to block the water to flow to said faucet.

17. The method, as recited in claim 16, wherein the step (a) further comprises a step of forming at least a marker being on a top surface of the counter to align with said switch means thereunder, wherein said hosting object is guided for being placed on the top surface of the counter to magnetically connected to said switch means.

18. The method, as recited in claim 16, wherein said switch means is a magnetic reed switch for being mounted on a bottom surface of the counter, wherein and said hosting object comprises a magnetic element that instigates activation of said magnetic reed switch, wherein said valve means is a solenoid for operatively mounting to the water outlet.

19. The water method, as recited in claim 16, wherein said faucet is a handle-less faucet.

20. The method, as recited in claim 16, wherein the step (b) further comprises the steps of:
(b.1) operatively connecting a relay switch between said switch means and said valve means;
(b.2) operatively connecting said valve means with a power source via a wiring system; and
(b.3) operatively connecting a cut-off safety switch between said wiring system and said power source.
